(19) United States
(12) Patent Application Publication
(10) Pub. No.: US 2020/0016613 A1
(43) Pub. Date: Jan. 16, 2020

(54) MULTI-PORT DISPENSING DEVICE

(71) Applicant: H5 ENTERPRISES, LLC, North Liberty, IA (US)

(72) Inventor: Robert D. Hajek, North Liberty, IA (US)

(21) Appl. No.: 16/509,561

(22) Filed: Jul. 12, 2019

Related U.S. Application Data
(60) Provisional application No. 62/697,031, filed on Jul. 12, 2018.

(51) Int. Cl. B05B 1/16; B05B 12/14

(52) U.S. Cl. CPC B05B 1/1681; B05B 1/169; B05B 12/1472; B05B 12/1409

(57) ABSTRACT

A multi-port dispensing device has a manifold with a top, a bottom, sides, and ends. An inlet conduit and a handle are connected to the manifold with the inlet conduit in communication with an inlet port in the manifold. A plurality of outlet conduits are connected to the manifold with each outlet conduit in communication with an outlet port in the manifold. A bottle or a nozzle are connected to the outlet ports. A shut-off valve on the bottle or outlet conduit permits and prevents flow from the manifold through the outlet conduits.

### CROSS REFERENCE TO RELATED APPLICATION

This application claims the benefit of the priority of U.S. Provisional Application No. 62/697,031 filed on Jul. 12, 2018, the contents of these applications are hereby incorporated by reference in their entirety.

### BACKGROUND OF THE INVENTION

This invention is directed to a dispensing device and more particularly a multi-port dispensing device.

Dispensing devices are well-known in the art and are used for a number of different applications such as washing a car or a house, washing windows, spraying for bugs such as mosquitos or the like, or fertilizing a garden to name a few. For each of these applications there is sometimes a need to mix a prepared composition with water for a single use application. To do so, an individual typically mixes the prepared composition with the water in a bucket or simply uses a hand held hose.

While useful, this process can be time consuming and requires the use of a bucket and sometimes the connecting or disconnecting of other devices for application. Accordingly, a need exists in the art for a device that makes the process easier.

An objective of the present invention is to provide a multi-port dispensing device that makes washing, spraying, and/or fertilizing easier.

Another objective of the present invention is to provide a multi-port dispensing device that makes washing, spraying and/or fertilizing less time consuming and use less water.

These and other objectives will be apparent to those having ordinary skill in the art based upon the following written description, drawings, and claims.

### SUMMARY OF THE INVENTION

A multi-port dispensing device includes a manifold having an inlet port and a plurality of outlet ports. Connected to the manifold and in communication with the inlet port is an inlet conduit. The inlet conduit has a connecting member at an outer end that is adapted to permit connection to a water hose.

Also connected to the manifold is a handle that is positioned to permit a user to hold the handle with one hand and the inlet conduit with the other. Further connected to the manifold are a plurality of outlet conduits wherein a conduit is in fluid communication with an outlet port.

Connected to the outer ends of the plurality of outlet conduits are either a bottle or a nozzle. Shut-off valves are positioned either on the bottles or the outlet conduits to selectively control the flow of fluid from the manifold through the outlet conduits.

### BRIEF DESCRIPTION OF THE DRAWINGS

FIG. 1 is a perspective view of a multi-port dispensing device;

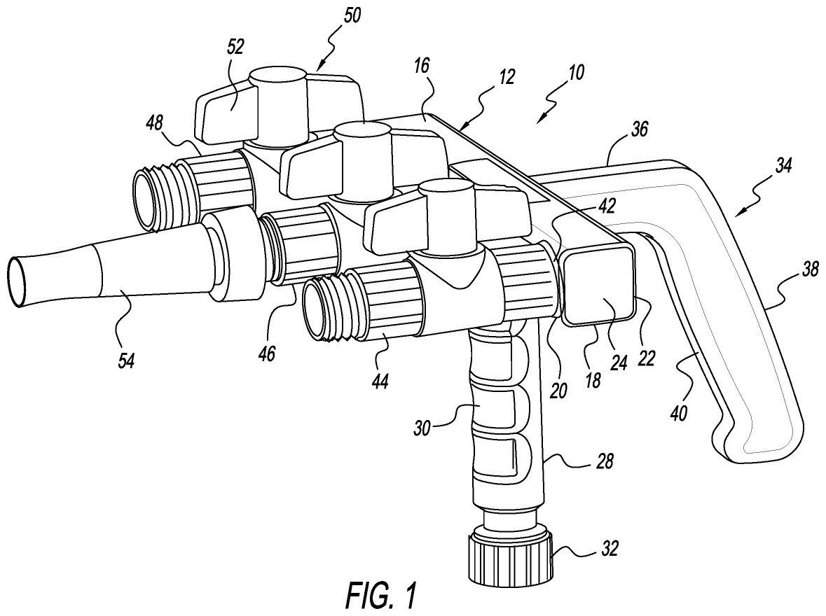

FIG. 2 is a side view of a multi-port dispensing device;

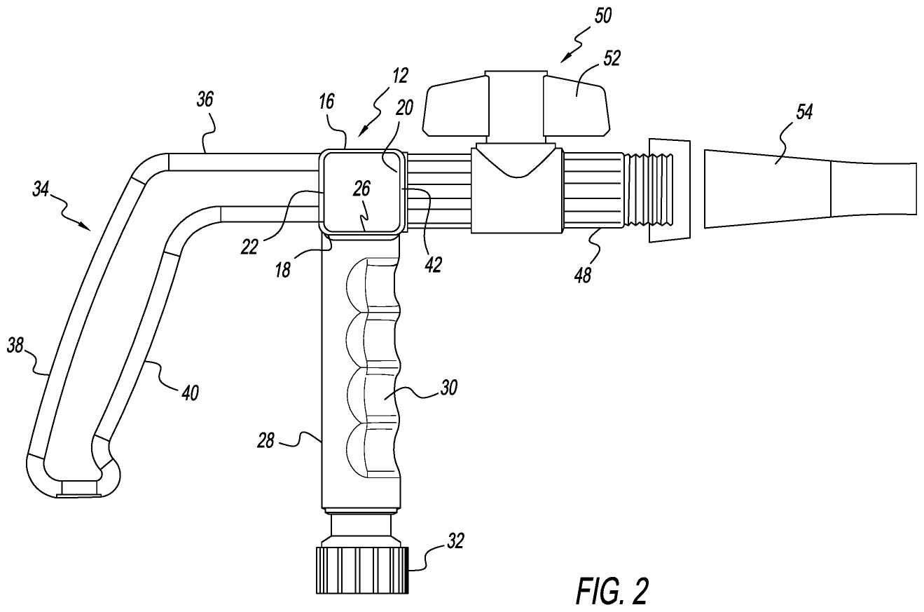

FIG. 3 is a side view of bottles for use with a multi-port dispensing device;

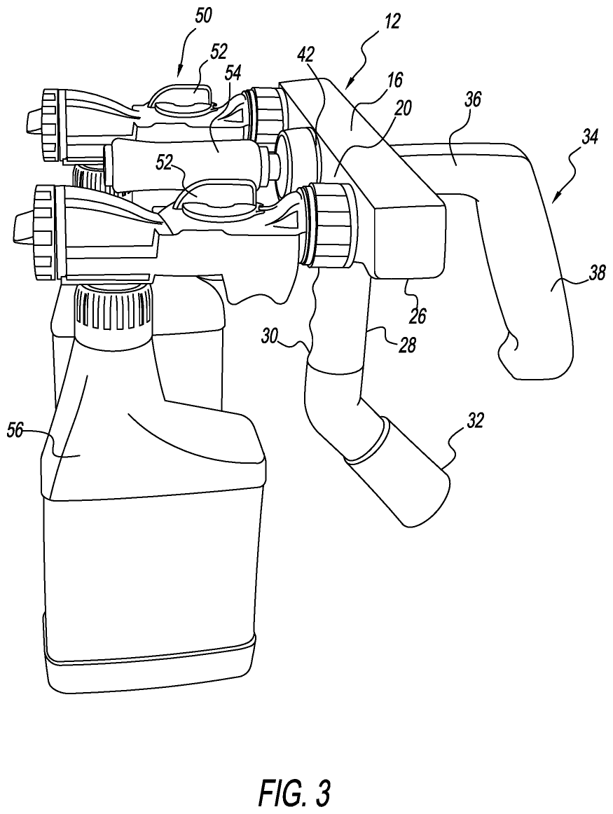

FIG. 4 is a perspective view of a multi-port dispensing device; and

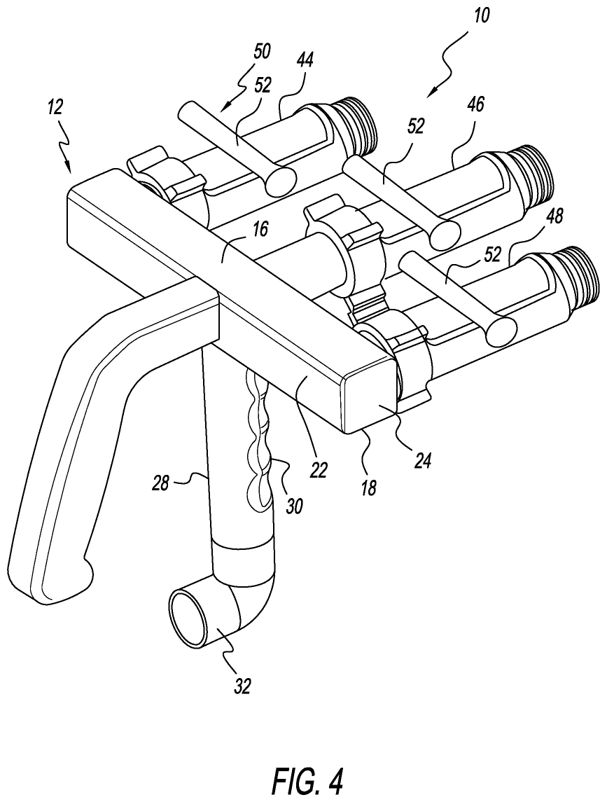

FIG. 5 is a top plan view of a multi-port dispensing device.

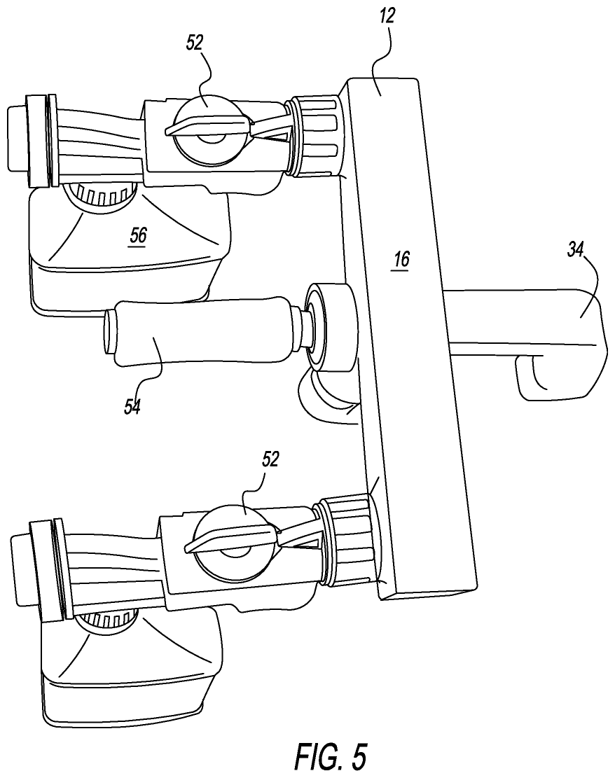

### DETAILED DESCRIPTION OF THE PREFERRED EMBODIMENTS

Referring to the Figures, a multi-port dispensing device 10 includes a manifold 12 having a top wall 16, a bottom wall 18, a first or front sidewall 20, a second or back sidewall 22 and end walls 24. The bottom wall 18 has an inlet port 26 in communication with an inlet conduit 28. The inlet conduit 28 is of any size, type and structure and in one example has a gripping section 30 adopted to receive an individual's fingers and at one end a connecting member 32. The connecting member 32 is adapted to connect to the end of a garden hose (not shown) or the like.

Extending outwardly away from the second sidewall 22 is a handle 34. The handle 34 is of any type, size, and structure. In the example shown, the handle 34 has a first section 36 that dwells generally in the same horizontal plane as the manifold 12 and a downwardly extending second section 38 that is transverse or angled in relation to the first section 36. The second section 38 has a gripping portion 40 adapted to be grasped by the individual's other hand.

The first sidewall 20 has a plurality of ports 42. Any number of ports can be used and preferably the device has three ports. Extending outwardly from the first sidewall 20 and in communication with ports 42 are elongated conduits 44, 46, and 48. Each of the conduits 44, 46, and 48 have a shut-off valve 50 that selectably prevents fluid from flowing through the conduits 44, 46, and 48. The shut-off valve 50 is of any type, size, and structure and is activated by a rotatable or slidable knob or lever 52.

The end of each conduit 44, 46, and 48 are threaded and are adapted to threadably receive a nozzle 54 or a bottle 56 containing soap, a rinsing composition, bug spray, fertilizer, or the like.

In another embodiment, none of the conduits 44, 46, and 48 have a shut-off valve and instead, the shut-off valves are located on the bottles 56. Also, the middle conduit 46 is longer than the outer conduits 44 and 48 to provide support when tipped and is flush with the outer portion of the bottles.

In operation, the inlet conduit 28 is connected to a hose that supplies a fluid such as water or the like using the connecting member 32. A nozzle 54 is threadably connected to the threaded end of conduit 46, a bottle 56 containing soap is connected to the threaded end of conduit 44, and a bottle 56 of rinsing agent is connected to the threaded end of conduit 48. Alternatively, a bottle 56 is connected to the threaded end of each conduit. Each bottle 56 has a turn valve that is opened.

With all shut-off valves 50 in a closed position, the water supply is turned on and water flows through the hose and into the inlet conduit 28, and from the inlet conduit 28 through inlet port 26 into the manifold 12. The user, by selecting and opening various shut-off valves 50 can cause fluid to flow from manifold 12 through conduit 46 and nozzle 54, or a mixture of water and soap or rinsing agent. When the shut-off valves for conduits 44 and 48 are opened fluid flows through conduits 44 and 48 and through the nozzle of the bottles 56. The bottles have a syphoning tube that supplies a composition such as soap or rinsing agent to the nozzle of the bottle 56 where the fluid and composition are discharged.

From the above discussion and accompanying figures and claims it will be appreciated that the multi-port dispensing device 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. A multi-port dispensing device comprising:
a manifold having an inlet port and a plurality of outlet ports;
a handle connected to the manifold;
an inlet conduit connected to the manifold and in communication with the inlet port; and
a plurality of conduits connected to and each in communication with one of the plurality of outlet ports.

2. The device of claim 1 wherein the manifold has a top wall, a bottom wall, a first sidewall, a second sidewall, and end walls.

3. The device of claim 1 wherein the plurality of outlet ports are in the first sidewall and the bottom port.

4. The device of claim 1 where in the inlet conduit has a gripping section and a connecting member.

5. The device of claim 1 wherein the handle has a first section and a second section.

6. The device of claim 1 wherein each of the plurality of conduits have a shut-off valve.

7. The device of claim 1 wherein one of the plurality of conduits is longer than the other plurality of conduits.

8. The device of claim 1 wherein a nozzle is connected to one of the plurality of conduits.

9. The device of claim 1 wherein a bottle is connected to at least one of the plurality of conduits.
